(19) United States
(12) Patent Application Publication
(10) Pub. No.: US 2008/0011685 A1
(43) Pub. Date: Jan. 17, 2008

(54) Water-Softening Product, Its Preparation And Its Use

(75) Inventors: Fabio Corradini, Mira (IT); Emanuele Rossetto, Mira (IT)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 11/568,818

(22) PCT Filed: May 16, 2005
(86) PCT No.: PCT/IB05/01684

§ 371 Date: Nov. 20, 2006

(30) Foreign Application Priority Data
May 14, 2004 (GB) 0410744.7

(51) Int. Cl. C02F 5/10; C02F 1/68

(52) U.S. Cl. 210/679; 428/332

(57) ABSTRACT

A process for the preparation of a water-softening product, the process comprises: d) distributing onto a first web up to 1300 gm⁻² of a water-softening composition; e) sealing a second web to the first web; and cutting the combined first and second webs to form the water-softening product in the form of a flat container of size in the range from 80 to 300 cm² and containing at least 5 g of water-softening composition.

This invention relates to a water-softening product and to a process for its preparation, and to its use in a water-softening method.

It is well known that certain metal compounds, notably calcium compounds, have a significant effect on the properties of water. “Hard” water containing a significant loading of soluble calcium and magnesium compounds form a scum with soap or detergent and may require a larger amount of detergent in order to provide an efficient clean. Scale deposits can readily form from such water, for example on heating or pH change or evaporation. These deposits can be encrustations, or watermarks left on evaporation of water droplets from, especially, a shiny surface. In addition hard water can form encrustations on fabric washed using such water giving a harsh feel to the fabric.

There have been many proposals for the removal of metal ions from aqueous solutions. In the industrial context proposals have included filter beds and polymeric filters for capturing heavy metal ions from an aqueous solution flowing within a passageway. Examples are given in EP-A-992238 and GB-A-20869564. In the domestic context sequestrants can be added to an aqueous washing solution and these can capture metal ions, such as calcium ions. Examples of such sequestrants are given in EP-A-892040.

However, consumers can be sceptical as to the benefits derived from the use of water-softening products since the benefits are not immediately obvious after a single use of the product; the benefits accumulate over time, for example preventing encrustation of heating elements or encrustation of deposits onto the fabric. Typically the water-softening product is consumed during the washing process and it is washed away, such as in the use of powder, tablets or liquid products.

In a multi-step washing process, such as that carried out by a clothes washing machine, it can be a problem that the water-softening product is discharged with the waste water, at an intermediate stage of the process, and is not available for later stages, such as the rinse cycle.

WO0218533 and WO0218280 describe water-softening products that are not necessarily consumed during washing processes, because they are not water-soluble, and which are too large to be washed away during any rinsing step.

We have found a simple process for the preparation of such products.

In accordance with a first aspect of the present invention there is provided a process for the preparation of a water-softening product, the process comprising:
a) distributing onto a first web up to 1300 gm⁻² of a water-softening composition;
b) sealing a second web to the first web; and
c) cutting the combined first and second webs to form the water-softening product in the form of a flat container of size in the range from 80 to 300 cm² and containing at least 5 g of water-softening composition.

In accordance with a further aspect of the present invention there is provided a water-softening product comprising a container containing a water-softening composition, the container being formed by the joining of two webs, the webs having held between them a water-softening composition distributed between the two webs at up to 1300 gm⁻² relative to either the top or the bottom web, wherein the container is flat, of size in the range 80 to 300 cm² and contains at least 5 g of water-softening composition.

In accordance with a further aspect of the present invention there is provided a method of softening water comprising contacting hard water with a product as defined herein.

A method of softening water may be a method used in a ware washing machine, for example a clothes washing machine or a dishwashing machine. Preferably the product is able to work through the wash and the rinse cycle of the machine; or only in the rinse cycle, or just in the washing cycle.

Alternatively a method in accordance with the invention may be a manual method, for example using a hand-cloth or mop, and an open vessel, for example a bucket or bowl. Thus, the cleaning method could be a method of cleaning a hard surface, for example a window, a tiled surface, shower screen, dirty tableware and kitchenware, a sanitaryware article, for example a lavatory, wash basin or sink, a car (which we regard as a “household article” within the terms of this invention) or a kitchen worktop, or it could be a method of hand-washing fabrics.

Water Softening Composition

The water softening composition may contain one or more water softening agents.

Preferably at least one water-softening agent, preferably making up the majority or all of the water-softening composition, is substantially water-insoluble.

By substantially water-insoluble water-softening agent we mean an agent, more than 50% wt, preferably at least 70% wt, more preferably at least 85% wt and most preferably at least 95% wt, and optimally 100% wt, of which is retained in the product, when the product is used under the most rigorous conditions for which it is intended (90° C.).

The composition could contain a water-soluble solid agent or a dispersible solid agent that is not water-soluble but which can pass through the walls of the container when immersed in water. Such a water-soluble or dispersible solid agent could be, for example, any possible component of compositions with which the product can be used.

When, the water-softening composition contains a water-soluble or water-dispersible solid agent, it may suitably constitute more than 70% wt of the water-softening composition, more preferably more than 90% wt and most preferably 95% wt.

Preferably the total amount of water-softening composition is between 5 and 25 g, ideally between 7 and 20 g.

Thus the water-softening product of the second aspect preferably contains 5 and 25 g, ideally between 7 and 20 g, of water-softening composition, (subject suitably to the stated upper limit of 1300 gm⁻² for the water-softening composition).

The composition is preferably substantially free of any surfactant and/or source of active oxygen (whether water-soluble or not).

The composition is preferably substantially free of any phosphonate compounds, and is preferably substantially free of all phosphorous-containing compounds.

By substantially free herein we mean less than 20% wt, 10% wt, 5% wt, less than 2% wt, less than 1% wt, ideally less than 0.5% wt, of such materials, relative to the total weight of the water-softening composition.

Preferably the water-softening composition is of particulate form or formed from a particulate material. Preferably the particle size distribution of the water softening composition is <0.2% at <100 microns and/or <0.1% at >2 mm.

Within the water-softening composition may be present an adhesive to bind the composition to one of the webs, such as polyethylene or ethylene vinyl acetate (preferably low melting point) added in particulate (i.e. powder/granular form) within the composition. Subsequent heating (by conventional ovens or IR or other sources) may melt the binder within the composition sticking it to one or more of the web surfaces.

Water-Insoluble Water Softening Agent

A water-insoluble agent (which may form all or part of the water-softening composition) could comprise polymeric bodies. Suitable forms include beads and fibres. Examples include polyacrylic acid and algins. The water-insoluble agent could alternatively be an inorganic material, for example a granular silicate or zeolite which is retained by the product walls.

The water-insoluble water softening agent may suitably be present in the water-softening composition in an amount of more than 1%, 5%, 10%, 20%, 30%, 40%, 50%, 60%, 70%, 80%, 90% and 95% wt thereof. Suitable maximum amounts may be less than 95%, 90%, 80%, 70%, 60%, 50%, 40%, 30%, 20% and 10% wt, based on the water-softening composition. A preferred range is 5-50% wt.

Sequestrant side chains may be grafted onto water-insoluble bodies (such as polymeric bodies), for example by using the well-known techniques of radiation grafting or chemical grafting. Radiation grafting is described in WO 94/12545. Chemical grafting is described in GB 2086954A. Alternatively for certain side chains the polymeric bodies may be fabricated (for example melt spun) already bearing the sequestrant side-chains, as described in EP 486934A. In yet other embodiments polymeric bodies not bearing sequestrant side chains may be coated with material which has the side chains. The polymeric bodies may, in effect, be regarded as carrying the side chains by mechanical adhesion. Alternatively they may attach by cross-linking, as described in EP 992283A.

Preferably sequestrant side chains are any side-chains which can be carried by polymeric bodies, and which are able to bind calcium (and preferably other) ions, and whose effectiveness in doing that is not substantially diminished by a cleaning agent. Suitable calcium-binding side-chains include residues of acids, for example of acrylic or methacrylic acid, or carboxylic acids, or of sulphonic acids, or of phosphonic acids. Residues of organic acids are preferred. Particularly preferred are residues of methacrylic or, especially, acrylic acid.

Alternative calcium-binding side chains of polymeric bodies may include amino groups, quaternary ammonium salt groups and iminodicarboxyl groups —N{(CH₂)ₙCOOH}₂, where n is 1 or 2.

Further suitable calcium-binding side chains of polymeric bodies may include acyl groups as described in EP 984095A. These have the formula
—C(O)—X(V)(Z)(M) or —C(O)—X(V)(Z) (S-M′)
where X represents a residue in which one carboxyl group is eliminated from a monocarboxylic acid or dicarboxylic acid;
V represents hydrogen or a carboxyl group;
M represents hydrogen; or 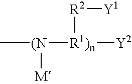
   wherein R¹ represents a residue in which one hydrogen is eliminated from a carbon chain in an alkylene group, R² represents a direct bond or an alkylene group, Y¹ and Y² are the same or different and each represents hydrogen, a carboxyl group, an amino group, a hydroxy group or a thiol group, n is an integer of 1 to 4, M′ represents hydrogen or 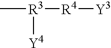
   wherein R³ represents a residue in which one hydrogen is eliminated from a carbon chain in an alkylene group; R⁴ represents a direct bond or an alkylene group, Y³ and Y⁴ are the same or different and each represents hydrogen, a carboxyl group, an amino group, a hydroxy group or a thiol group; and Z represents hydrogen or has the same meaning as that of M.

Such side chains are preferably carried by polymeric fibres selected from polyolefins, poly(haloolefins), poly(vinylalcohols), polyesters, polyamides, polyacrylics, protein fibres and cellulosic fibres (for example cotton, viscose and rayon). Polyolefins are especially preferred, particularly polyethylene and polypropylene.

When side chains are grafted onto the base polymeric bodies a preferred process is one using irradiation, in an inert atmosphere, with immediate delivery to irradiated bodies of acrylic acid. Preferably the radiation is electron beam or gamma radiation, to a total dose of 10-300 kGy, preferably 20-100 kGy. The acrylic acid is preferably of concentration 20-80 vol %, in water, and the temperature at which the acrylic acid is supplied to the irradiated polymeric bodies is preferably an elevated temperature, for example 30-80° C. Preferably the base polymeric bodies are polyethylene, polypropylene or cellulosic fibres.

In a preferred feature the water-insoluble agent comprises ion exchange resin, preferably cation exchange resin. Cation exchange resins may comprise strongly and/or weakly acidic cation exchange resin. Further, resins may comprise gel-type and/or macroreticular (otherwise known as macroporous)-type acidic cation exchange resin. The exchangeable cations of strongly acidic cation exchange resins are preferably alkali and/or alkaline earth metal cations, and the exchangeable cations of weakly acidic cation exchange resins are preferably H⁺ and/or alkali metal cations.

Suitable strongly acidic cation exchange resins include styrene/divinyl benzene cation exchange resins, for example, styrene/divinyl benzene resins having sulfonic functionality and being in the Na⁺ form such as Amberlite 200, Amberlite 252 and Duolite C26, which are macroreticular-type resins, and Amberlite IR-120, Amberlite IR-122, Amberlite IR-132, Duolite C20 and Duolite C206, which are gel-type resins. Suitable weakly acidic cation exchange resins include acrylic cation exchange resins, for example, Amberlite XE-501, which is a macroreticular-type acrylic cation exchange resin having carboxylic functionality and being in the H⁺ form, and Amberlite DP1 which is a macroreticular-type methacrylic/divinyl benzene resin having carboxylic functionality and being in the Na⁺ form.

Other forms of water-insoluble ion exchange agents can be used—such agents include alkali metal (preferably sodium) aluminosilicates (either crystalline, amorphous or a mixture of the two). Such aluminosilicates generally have a calcium ion exchange capacity of at least 50 mg CaO per gram of aluminosilicate, comply with a general formula:
0.8-1.5 Na₂O.Al₂O₃.0.8-6 SiO₂
and incorporate some water. Preferred sodium aluminosilicates within the above formula contain 1.5-3.0 SiO₂units. Both amorphous and crystalline aluminosilicates can be prepared by reaction between sodium silicate and sodium aluminate, as amply described in the literature.

Suitable crystalline sodium aluminosilicate ion-exchange detergency builders are described, for example, in GB 1429143 (Procter & Gamble). The preferred sodium aluminosilicates of this type are the well known commercially available zeolites A and X, and mixtures thereof. Also of interest is zeolite P described in EP 384070 (Unilever).

Another class of compounds for use in the composition of the present invention are the layered sodium silicate builders, such as are disclosed in U.S. Pat. No. 4,464,839 and U.S. Pat. No. 4,820,439 and also referred to in EP-A-551375.

These materials are defined in U.S. Pat. No. 4,820,439 as being crystalline layered, sodium silicate of the general formula
NaMSiₓO₂ₓ₊₁.YH₂O
where

M denotes sodium or hydrogen,

x is from 1.9 to 4 and y is from 0 to 20.

Quoted literature references describing the preparation of such materials include Glastechn. Ber. 37, 194-200 (1964), Zeitschrift für Kristallogr. 129, 396-404 (1969), Bull. Soc. Franc. Min. Crist., 95, 371-382 (1972) and Amer. Mineral, 62, 763-771 (1977). These materials function to remove calcium and magnesium ions from water. Also covered are salts of zinc which have also been shown to be effective water softening agents.

In principle, however, any type of insoluble, calcium-binding material can be used.

Preferably the water-insoluble water softening agent is also able to bind magnesium ions as well as calcium ions.

Water-Soluble Water Softening Agents

A water-soluble water softening agent may be present in the water-softening composition in an amount of more than 1%, 5%, 10%, 20%, 30%, 40%, 50%, 60%, 70%, 80%, 90% and 95% wt thereof. Desirable maximum amounts are less than 95%, 90%, 80%, 70%, 60%, 50%, 40%, 30%, 20% and 10% wt, based on the water-softening composition. A preferred range is 50-95% wt.

By the term “water-soluble” we include agents that are water dispersible. Such agents include:

1) Ion capture agents—agents which prevent metal ions from forming insoluble salts or reacting with surfactants, such as polyphosphate, monomeric polycarbonates, such as citric acid or salts thereof.

2) Anti-nucleating agents—agents which prevent seed crystal growth, such as polycarbonate polymers, for example polyacrylates, acrylic/maleic copolymers, phosphonates, and acrylic phosphonates and sulfonates.

3) Dispersing agents—agents that keep crystals suspended in solution, such as polyacrylate polymers.

Preferred Water-Softening Compositions

Preferred water-softening compositions contain, and most preferably consist of, the following:

acrylic acid copolymer or, preferably, homopolymer, preferably 5-60% wt, especially 20-40% wt; citric acid, preferably 1-30% wt, especially 5-20% wt; cationic exchange resin, preferably 1-30% wt, especially 3-10% wt; trisodium citrate, preferably 5-80% wt, especially 40-60% wt; optionally esterquat, preferably 0.1-5% wt, especially 0.2-2% wt, subject to the total being 100% wt of the water-softening composition (preferred) or less (i.e. other components present).

Water-Softening Composition Distribution

A feature of the invention is the distribution of the water-softening composition onto the webs. One of the most common methods of applying a coating is scatter coating. With this method it is possible to sprinkle the composition with a scatter roller on all types of substrates. Alternatively, composition may be transferred to the web via transfer printing, such as a gravure or flexo. Further alternatives may involve simple loading techniques and using doctor blades to even out the product. The composition may be fixed on to the substrate with the aid of heating, such as infrared heating, the composition preferably comprising a suitable fusible adhesive binder.

Paste coating may be employed, and is a liquid based dispersion of particulate materials making up the composition. Preferably a paste may be ground to up to 80 micron. This liquid based dispersion of the composition involves adding the composition components to the liquid. This paste is applied using a rotary screen printing method.

Powder rotary screen printing may be employed, using an engraved roller with spherical indents on to the substrate which is heated by heated rollers. The powder particles then melt into dots when they pass into the infrared oven.

Distribution is preferably even over the area of the web of the product. By even distribution we preferably mean that at any two points on the web there is less than a 25% difference in weight by composition, ideally less than 15%, 10% or 5%.

Distribution may be discontinuous, for example in strips, for example parallel to the web travel direction, or in discrete regions corresponding to the final patch dimensions. The benefit in each case is that the uncoated regions are adapted for easy web-to-web sealing prior to cutting.

When distribution has taken place it may be desirable to selectively remove the composition, to expose the web material and facilitate web-to-web sealing, when the water-softening composition is a loose particulate material, as is preferred, this may be done by precise blowing and/or vibration. However this may not be needed. The action of bringing the webs together for sealing could drive the water-softening composition from the seal zones, enabling a good web-to-web seal to be achieved.

Container

The container is formed into a flat container or a sachet from a sandwich of the two webs. A water permeable sheet or film is present in one of the webs, at least, and forms at least one wall of the container. Ideally at least water-permeable outer wall is present, for example of a woven, knitted or preferably non-woven material, of textile or paper. The material may be in the form of single layer or laminated layers. Preferably the wall comprises a sheet with a ply of one, two or three layers, such that any insoluble agent inside the container is too large to pass through the perforation(s) or would have to follow an impossible tortuous pathway if it were to exit the container through the wall. Preferably the sheet is a woven or non-woven material.

The first and second webs may be made from different materials. Preferably they are made from the same material. Preferably at least one web is water permeable.

The container consists of two webs sealed together about their periphery, with the contents held inside. The sealing may be by means of adhesive or dielectric welding or, preferably, heat sealing or, most preferably, ultrasound sealing. When the sealing is by heat sealing the sheets may comprise a thermoplastic to facilitate this. The material forming the adhesive strips can be a so called hot melt comprising various materials, such as APP, SBS, SEBS, SIS, EVA and the like, or a cold glue, such as a dispersion of various materials, e.g. SBS, natural rubber and the like, or even a solvent-based or a two-component adhesive system. Furthermore, the material may be capable of crosslinking to form specific, permanent chemical bonds with the various layers. The amount of adhesive is a function of the type of adhesive used, however it is generally between 0.2 and 20 g/m².

Sealing is further described later in this specification.

Conventional materials used in tea bag manufacture or in the manufacture of sanitary or diaper products may be suitable, and the techniques used in making tea bags or sanitary products can be applied to make flexible products useful in this invention. Such techniques are described in WO 98/36128, U.S. Pat. No. 6,093,474, EP 0708628 and EP 380127A.

Conveniently the two webs are non-wovens. Processes for manufacturing nonwoven fabrics can be grouped into four general categories leading to four main types of nonwoven products: textile-related, paper-related, extrusion-polymer processing related and hybrid combinations

Textiles. Textile technologies include garnetting, carding, and aerodynamic forming of fibres into selectively oriented webs. Fabrics produced by these systems are referred to as drylaid nonwovens, and they carry terms such as garnetted, carded, and airlaid fabrics. Textile-based nonwoven fabrics, or fibre-network structures, are manufactured with machinery designed to manipulate textile fibres in the dry state. Also included in this category are structures formed with filament bundles or tow, and fabrics composed of staple fibres and stitching threads.

In general, textile-technology based processes provide maximum product versatility, since most textile fibres and bonding systems can be utilised.

Paper. Paper-based technologies include drylaid pulp and wetlaid (modified paper) systems designed to accommodate short synthetic fibers, as well as wood pulp fibres. Fabrics produced by these systems are referred to as drylaid pulp and wetlaid nonwovens. Paper-based nonwoven fabrics are manufactured with machinery designed to manipulate short fibres suspended in fluid.

Extrusions. Extrusions include spunbond, meltblown, and porous film systems. Fabrics produced by these systems are referred to individually as spunbonded, meltblown, and textured or apertured film nonwovens, or generically as polymer-laid nonwovens. Extrusion-based nonwovens are manufactured with machinery associated with polymer extrusion. In polymer-laid systems, fiber structures simultaneously are formed and manipulated.

Hybrids. Hybrids include fabric/sheet combining systems, combination systems, and composite systems. Combining systems employ lamination technology or at least one basic nonwoven web formation or consolidation technology to join two or more fabric substrates. Combination systems utilize at least one basic nonwoven web formation element to enhance at least one fabric substrate. Composite systems integrate two or more basic nonwoven web formation technologies to produce web structures. Hybrid processes combine technology advantages for specific applications.

Sealing

Ultrasonic welding is preferred and is the sealing through the use of heat generated from high-frequency mechanical motion. It is accomplished by converting high-frequency electrical energy into high-frequency mechanical motion. The mechanical motion, along with applied force, creates frictional heat at the webs surfaces (joint area) so the material will melt and form a molecular bond between the parts. Suitable ultrasonic welders are available from companies, such as, Dukane, St Charles, Ill., USA or Sonobond, West Chester, Pasadena, USA. Other options including thermal sealing (via direct heat or UV) are available.

The product could be discarded after use, or it could be regenerated when certain water-softening agents are used, for example cation exchange resins by using sodium chloride to effect ion exchange.

Furthermore the wall of the container may itself act as a further means for modifying the water, for example by having the capability of capturing undesired species in the water and/or releasing beneficial species. Thus, the wall material could be of a textile material with ion-capturing and/or ion-releasing properties, for example as described above, such a product may be provided by following the teaching of WO 0218533 that describes suitable materials.

The container preferably has a size (area) of between 80 to 300 cm², ideally 100 to 200 cm².

The product may be placed with the items to be marked in a fabric washing machine.

Alternatively the product may pack into the flow pathway for the rinse or wash water of a ware washing machine such that the water is compelled to flow through it. This is an efficient approach to softening the water used in clothes washing machines.

The set-up may be for only rinse water to flow through it; thus, suitably the main wash water will not have flowed through the product, but softening thereof is effected by the conventional builders present in the laundry detergent composition. Prior to rinsing, the wash water containing the builders is drained away and only then is the rinse water delivered into the machine, this rinse water having been softened by flowing through the product located in the loading tray. Neither the builders nor the sequestrant in the product are active at the same time as the other. Thus, they do not compete with each other and are not used wastefully.

Cutting

Cutting may be carried out, to separate individual containers by any available means, including but not limited to crush cutting, scissor cutting and sliding or traverse blade cutting. In most practical manufacturing situations cutting is effected in two orthogonal directions, longitudinal to the web and transverse to the web.

Packaging

Preferably the product is held in a packaging system that provides a moisture barrier.

The packaging may be formed from a sheet of flexible material. Materials suitable for use as a flexible sheet include mono-layer, co-extruded or laminated films. Such films may comprise various components, such as poly-ethylene, poly-propylene, poly-styrene, poly-ethylene-terephtalate or metallic foils such as aluminium foils. Preferably, the packaging system is composed of a poly-ethylene and bi-oriented-poly-propylene co-extruded film with an MVTR of less than 30 g/day/m² The MVTR of the packaging system is preferably of less than 25 g/day/m², more preferably of less than 22 g/day/m² The film may have various thicknesses. The thickness should typically be between 10 and 150 μm, preferably between 15 and 120 μm, more preferably between 20 and 100 μm, even more preferably between 30 and 80 μm and most preferably between 40 and 70 μm.

Among the methods used to form the packaging over the container are the wrapping methods disclosed in WO92/20593, including flow wrapping or over wrapping. When using such processes, a longitudinal seal is provided, which may be a fin seal or an overlapping seal, after which a first end of the packaging system is closed with a first end seal, followed by closure of the second end with a second end seal. The packaging system may comprise re-closing means as described in WO92/20593. In particular, using a twist, a cold seal or an adhesive is particularly suited. Alternatively the packaging may be in the form of a sealable bag that may contain one or more (greater than ten but less than forty) sachets.

MVTR can be measured according to ASTM Method F372-99, being a standard test method for water vapour transfer rate of flexible barrier materials using an infrared detection technique.

A product may be disposed in a clothes washing machine throughout the wash and rinse cycles, for example by being placed in the machine's drum with laundry to be washed. Alternatively a product may be disposed in the rinse and/or the wash portion of the dispensing drawer of a clothes washing machine, such that rinse and/or wash water flowing through the loading drawer and into the machine is rendered lower in calcium ion concentration.

In this specification percentage values, indicated by the symbols % or % wt, denote weight of the stated component expressed as a percentage of the total composition weight unless otherwise stated.

The invention will now be described, by way of example, with reference to the following embodiments.

Sachets were made with the following contents:

| | Example | | | | | | | | | | | | | |
|---|---|---|---|---|---|---|---|---|---|---|---|---|---|---|
| | 1 | | 2 | | 3 | | 4 | | 5 | | 6 | | 7 | |
| Actives in | Amt | | Amt | | Amt | | Amt | | Amt | | Amt | | Amt | |
| Sachet | (g) | Wt. % | (g) | Wt. % | (g) | Wt. % | (g) | Wt. % | (g) | Wt. % | (g) | Wt. % | (g) | Wt. % |
| Acrylic acid | 5.00 | 42.7 | 6.00 | 56.1 | 3.84 | 29.0 | 4.80 | 28.6 | 5.00 | 39.3 | 4.00 | 34.8 | 4.50 | 30.6 |
| homopolymer | | | | | | | | | | | | | | |
| Citric Acid | 2.85 | 24.4 | 3.00 | 28.0 | 5.43 | 41.0 | 6.79 | 40.4 | 2.85 | 22.4 | 2.50 | 21.7 | 1.6 | 10.9 |
| Phosphonate | 0.10 | 0.9 | 0.15 | 1.4 | 0.10 | 0.8 | 0.10 | 0.6 | 0.10 | 0.8 | 0.10 | 0.9 | — | — |
| chelating agent | | | | | | | | | | | | | | |
| Cation | 3.00 | 25.6 | 1.10 | 10.3 | 3.00 | 22.6 | 4.00 | 23.8 | 4.00 | 31.4 | 4.00 | 34.8 | 1.00 | 6.8 |
| Exchange | | | | | | | | | | | | | | |
| Resin | | | | | | | | | | | | | | |
| Water | 0.25 | 2.1 | 0.25 | 2.3 | 0.80 | 6.0 | 0.90 | 5.4 | 0.70 | 5.5 | 0.70 | 6.1 | — | — |
| absorbent | | | | | | | | | | | | | | |
| polymer | | | | | | | | | | | | | | |
| Esterquat | 0.50 | 4.3 | 0.20 | 1.9 | 0.09 | 0.68 | 0.20 | 1.2 | 0.085 | 0.67 | 0.20 | 1.7 | 0.10 | 0.7 |
| Trisodium | — | — | — | — | — | — | — | — | — | — | — | — | 7.50 | 51.0 |
| citrate | | | | | | | | | | | | | | |
| Total (grams) | 11.7 | | 10.7 | | 13.26 | | 16.79 | | 12.74 | | 11.5 | | 14.7 | |

The webs were made of polypropylene nonwoven sheet material Leutrasil™ from Freudenberg Nonwovens. The sachets were made in accordance with the technical teachings of WO 98/36128 and EP 380127A. They were square, 12 cm×12 cm, and contained their contents as a loose charge of particulates. The periphery was cleanly sealed, and cut to form the individual sachets.

Ten sachets were held in a bag made from the following material and stored in a standard non-waxed cardboard box. In addition ten identical sachets were stored in the same standard non-waxed cardboard box but without being packed in the bag. Standard storage conditions were used, which may be defined as 25° C. at 50% relative humidity for 6 weeks. After storage the sachets were inspected for visible degradation and tested for performance.

Packaging Description
The sachets were made from reeled polythene film, 380 mm wide.

| | | THICKNESS |
|---|---|---|
| GENERIC NAME | MANUFACTURER | (μm) |
| Polyethylene | ASPLA, Torrelavega | 60 |
| LDPE-LLDPE | (Santander, Spain) | |

| PERFORMANCE | | Value |
|---|---|---|
| 1.1 | Tensile strength (Machine Direction) | >20 N/MM2 |
| 1.2 | Coefficient of friction | — |
| | Internal | <0.25 |
| | External | <0.25 |
| 1.3 | Barrier properties | |
| | Oxygen transmission | 4000 cc/m²/24 hr |
| | Water vapour transmission | 20 grs./m²/24 hr |

| | Supplier |
|---|---|
| Supplier's Name | Aspla |
| Site of Manufacturer | Torrelavega |
| | (Santander) |

1. A process for the preparation of a water-softening product, the process comprising:
a) distributing onto a first web up to 1300 gm⁻² of a water-softening composition;
b) sealing a second web to the first web; and
c) cutting the combined first and second webs to form the water-softening product in the form of a flat container of size in the range from 80 to 300 cm² and containing at least 5 g of water-softening composition.

2. A water-softening product comprising a container containing a water-softening composition, the container being formed by the joining of two webs having held between a water-softening composition, and distributed between the two webs at up to 1300 gm⁻² of either top or bottom web, wherein the container is flat, of size in the range 80 to 300 cm² and contains at least 5 g of water-softening composition.

3. A product as claimed in claim 2 wherein the water-softening composition contains at least one water-softening agent which is a cation exchange resin.

4. A water-softening product as claimed in claim 2 wherein the water-softening composition contains at least one water-softening agent which is substantially water-insoluble.

5. A water-softening product as claimed in claim 2 wherein the water-softening composition contains at least one water-softening agent which is substantially water soluble.

6. A water-softening product according to claim 2 wherein the container is of size in the range from 100 to 200 cm².

7. A water-softening product according to claim 2 wherein the container contains from 7 to 25 g of water-softening composition.

8. A water-softening product according to claim 2 wherein at least one web is a non-woven material.

9. A method of softening water comprising contacting hard water with a water softening product according to claim 2.

10. A method as claimed in claim 9 wherein the method is a method used in a ware washing machine.

11. A water-softening product as claimed in claim 3 wherein the water-softening composition contains at least one water-softening agent which is substantially water-insoluble.

12. A water-softening product as claimed in claim 3 wherein the water-softening composition contains at least one water-softening agent which is substantially water soluble.

13. A water-softening product according to claim 3 wherein the container is of size in the range from 100 to 200 cm².

14. A water-softening product according to claim 3 wherein the container contains from 7 to 25 g of water-softening composition.

15. A water-softening product according to claim 3 wherein at least one web is a non-woven material.
